(19) United States
(12) Patent Application Publication
(10) Pub. No.: US 2007/0043539 A1
(43) Pub. Date: Feb. 22, 2007

(54) Abnormality monitoring system and abnormality monitoring method

(75) Inventors: Nobuhiro Niina, Tokyo (JP); Kazuo Sueyoshi, Tokyo (JP); Takamasa Yumoto, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/432,946

(22) Filed: May 12, 2006

(30) Foreign Application Priority Data
May 17, 2005 (JP) 2005-144625

(51) Int. Cl. G06F 11/00; G06F 15/00

(52) U.S. Cl. 702/188

(57) ABSTRACT

A simulation section simulates an operation of a field device in the plant by using a device model. A comparing section compares actual output data of the field device with simulation output data that is obtained by simulation by the simulation section. A judging section judges occurrence of abnormality of the plant based on a comparison result by the comparing section. An error estimating section estimates an error between process data and input data, the process data being indicated as the input data to the field device, and the input data being actually inputted to the field device. In this case, the process data is corrected based on an estimation result by the error estimating section, and the corrected process data is inputted to the device model.

This application claims foreign priority based on Japanese Patent application No. 2005-144625, filed May 17, 2005, the content of which is incorporated herein by reference in its entirety.

### BACKGROUND OF THE INVENTION

1. Field of the Invention

The present invention relates to an abnormality monitoring system and an abnormality monitoring method for monitoring abnormality of a plant.

2. Description of the Related Art

An abnormality monitoring system for detecting abnormality of a plant based on an operation state of a field device arranged in a plant such as a petroleum plant, a chemical plant, a petrochemical plant or a steel plant has been known (for example, refer to JP-A-2004-54555).

In a related abnormality monitoring system, process data handled in a field device is applied to a calculation expression constructed by four arithmetic operations and the presence or absence of abnormality is determined based on a calculated value. However, a complicated model represented by simultaneous equations or simultaneous differential equations cannot be defined, and an operation state of the field device cannot be represented exactly by a calculation expression, so that accuracy of abnormality detection cannot be improved.

Also, in the field device, an operation state varies according to environment used, so that it is necessary to adjust a calculation expression or parameters used in the calculation expression at the user side. However, specialized knowledge of chemical engineering or advanced mathematics, etc., is required in generation of the calculation expression. Also, in the case of determining the parameters of the calculation expression, it has no choice but to adjust plural parameters while changing the parameters gradually and determine the parameters by trial and error, and it takes a lot of time or labor to adapt the parameters.

Further, in the case of diagnosing the presence or absence of abnormality based on a calculation result by a calculation expression, the calculation result is compared with a predetermined threshold value. However, in order to decide the threshold value used in such abnormal diagnosis, it has no choice but to determine the threshold value while looking at a state of a process and changing the threshold value gradually, and it takes a lot of time or labor to adapt the threshold value.

### SUMMARY OF THE INVENTION

The present invention has been made in view of the above circumstances, and provides an abnormality monitoring system and an abnormality monitoring method capable of monitoring abnormality of a plant with high accuracy without requiring troublesome work.

In some implementations, an abnormality monitoring system of the invention for monitoring abnormality of a plant comprises:

a simulation section which simulates an operation of a field device in the plant by using a device model;

a comparing section which compares actual output data of the field device with simulation output data that is obtained by simulation by the simulation section; and a judging section which judges occurrence of abnormality of the plant based on a comparison result by the comparing section.

According to this abnormality monitoring system, an operation of a field device is simulated using a device model, so that the operation of the field device can be monitored with high accuracy.

The abnormality monitoring system of the invention may further comprise:

an error estimating section which estimates an error between process data and input data, the process data being indicated as the input data to the field device, and the input data being actually inputted to the field device,

wherein the process data is corrected based on an estimation result by the error estimating section, and

the corrected process data is inputted to the device model.

In this case, the operation of the field device can be monitored with higher accuracy since the process data corrected based on the estimation result of an error is inputted to the device model.

The judging section may judge the occurrence of the abnormality based on duration time for which a difference between the simulation output data and the actual output data compared by the comparing section exceeds a threshold value.

The judging section may judge the occurrence of the abnormality based on a number of times for which a difference between the simulation output data and the actual output data compared by the comparing section exceeds a threshold value within a predetermined time.

The judging section may judge the occurrence of the abnormality based on accumulation time for which a difference between the simulation output data and the actual output data compared by the comparing section exceeds a threshold value within a predetermined time.

The abnormality monitoring system of the invention may further comprise:

a threshold value defining section which defines the threshold value based on an instruction of a user.

The abnormality monitoring system of the invention may further comprise:

a storage section which stores an operation history of the field device; and

a display which displays the operation history stored in the storage section on a screen,

wherein the threshold value defining section accepts the instruction of the user on the screen of the display.

In this case, the threshold value can easily be set at a proper value since the instruction of the user is accepted on the screen.

The abnormality monitoring system of the invention may further comprise:

a device model parameter defining section which defines the device model based on an instruction of a user.

The abnormality monitoring system of the invention may further comprise:

a storage section which stores an operation history of the field device; and

a display which displays the operation history stored in the storage section on a screen, wherein the device model parameter defining section accepts the instruction of the user on the screen of the display.

In this case, a proper device model can easily be set since the instruction of the user is accepted on the screen. In this case, an input of a value of a model parameter for defining a parameter of the device model may be accepted.

In some implementations, an abnormality monitoring system for monitoring abnormality of a plant comprises:

a judging section which judges occurrence of abnormality of the plant-based on a judgment criterion and an operation of a field device in the plant;

a storage section which stores an operation history of the field device;

a display which displays the operation history stored in the storage section on a screen; and

an accepting section which accepts an input of the judgment criterion by a user on the screen of the display.

According to this abnormality monitoring system, an input of the judgment criterion by a user is accepted on the screen on which an operation history is displayed, so that a proper judgment criterion can be set easily. The judgment criterion includes a threshold value, etc., used as the judgment criterion.

The judging section may judge the occurrence of the abnormality by using a threshold value corresponding to the judgment criterion.

The accepting section may accept the input of the threshold value by designation of a region by the user on the screen.

In some implementations, an abnormality monitoring method of the invention for monitoring abnormality of a plant comprises:

simulating an operation of a field device in the plant by using a device model;

comparing actual output data of the field device with simulation output data that is obtained by the simulation; and

judging occurrence of abnormality of the plant based on a result of the comparison.

According to this abnormality monitoring method, an operation of a field device is simulated using a device model, so that the operation of the field device can be monitored with high accuracy.

The abnormality monitoring method of the invention may further comprise:

estimating an error between process data and input data, the process data being indicated as the input data to the field device, and the input data being actually inputted to the field device,

wherein the process data is corrected based on a result of the estimation, and the corrected process data is inputted to the device model.

In this case, the operation of the field device can be monitored with higher accuracy since process data corrected based on an estimation result of an error is inputted to the device model.

The occurrence of the abnormality may be judged based on duration time for which a difference being compared between the simulation output data and the actual output data exceeds a threshold value.

The occurrence of the abnormality may be judged based on a number of times for which a difference being compared between the simulation output data and the actual output data exceeds a threshold value within a predetermined time.

The occurrence of the abnormality may be judged based on accumulation time for which a difference being compared between the simulation output data and the actual output data exceeds a threshold value within a predetermined time.

The abnormality monitoring method of the invention may further comprise:

defining the threshold value based on an instruction of a user.

The abnormality monitoring method of the invention may further comprise:

storing an operation history of the field device; and

displaying the stored operation history on a screen,

wherein the threshold value is defined by accepting the instruction of the user on the screen.

In this case, the threshold value can easily be set at a proper value since the instruction of the user is accepted on the screen.

The abnormality monitoring method of the invention may further comprise:

defining the device model based on an instruction of a user.

The abnormality monitoring method of the invention may further comprise.:

storing an operation history of the field device; and

displaying the stored operation history on a screen,

wherein the device model is defined by accepting the instruction of the user on the screen.

In this case, a proper device model can easily be set since the instruction of the user is accepted on the screen. In this case, an input of a value of a model parameter for defining a parameter of the device model may be accepted.

In some implementations, an abnormality monitoring method of the invention for monitoring abnormality of a plant comprises:

judging occurrence of abnormality of the plant based on a judgment criterion and an operation of a field device in the plant;

storing an operation history of the field device;

displaying the stored operation history on a screen; and

accepting an input of the judgment criterion by a user on the screen.

According to this abnormality monitoring method, an input of the judgment criterion by a user is accepted on a screen on which an operation history is displayed, so that a proper judgment criterion can be set easily. The judgment criterion includes a threshold value, etc., used as the judgment criterion.

In the abnormality monitoring method of the invention, the occurrence of the abnormality may be judged by using a threshold value corresponding to the judgment criterion.

In the abnormality monitoring method of the invention, the input of the threshold value is accepted by designation of a region by the user on the screen.

According to the abnormality monitoring system of the invention, an operation of a field device is simulated using a device model, so that the operation of the field device can be monitored with high accuracy. Also, according to the Abnormality monitoring system of the invention, an input of a judgment criterion by a user is accepted on a display screen on which an operation history is displayed, so that a proper judgment criterion can be set easily.

According to the abnormality monitoring method of the invention, an operation of a field device is simulated using a device model, so that the operation of the field device can be monitored with high accuracy. Also, according to the abnormality monitoring method of the invention, an input of a judgment criterion by a user is accepted on a display screen on which an operation history is displayed, so that a proper judgment criterion can be set easily.

### BRIEF DESCRIPTION OF THE DRAWINGS

FIGS. 1A and 1B are block diagrams functionally showing abnormality monitoring systems according to embodiments of the invention.

FIG. 2 is a block diagram showing a configuration of a plant control system to which the abnormality monitoring system of a first embodiment is applied.

FIGS. 3A and 3B are flowcharts showing a processing procedure of abnormal monitoring.

FIG. 4 is a diagram illustrating a display screen at the time of changing a model parameter.

FIG. 5 is a diagram illustrating a display image for setting a threshold value.

### DESCRIPTION OF THE PRFERRED EMBODIMENTS

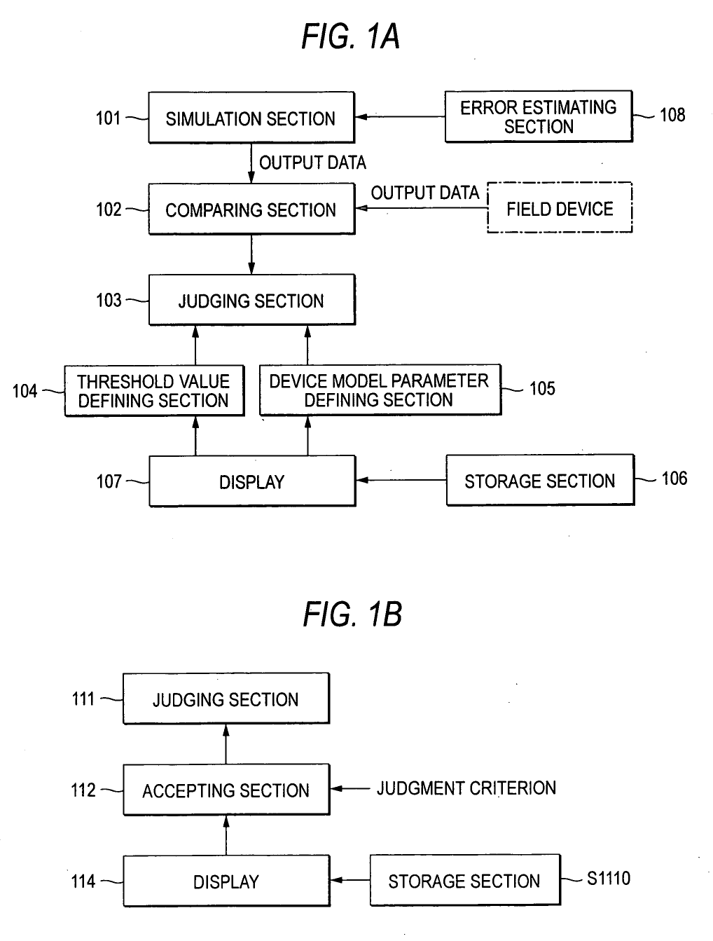

FIGS. 1A and 1B are block diagrams functionally showing abnormality monitoring systems according to embodiments of the invention.

In a case of FIG. 1A, a simulation section 101 simulates an operation of a field device in a plant using a device model. A comparing section 102 compares actual output data of the field device with output data obtained by simulation by the simulation section 101. A judging section 103 judges occurrence (presence or absence) of abnormality of the plant based on a comparison result by the comparing section 102.

An error estimating section 108 estimates an error between process data indicated as input data to the field device and input data actually inputted to the field device. In this case, process data corrected based on an estimation result by the error estimating section 108 is inputted to the device model.

Also, a threshold value defining section 104 defines a threshold value based on instructions of a user. A device model parameter defining section 105 defines a device model based on instructions of a user.

A storage section 106 stores an operation history of the field device. A display 107 displays the operation history stored in the storage section 106 on a screen. In this case, the threshold value defining section 104 accepts instructions by a user on a display screen by the display 107. Also, the device model parameter defining section 105 accepts instructions by a user on the display screen of the display 107.

In a case of FIG. 1B, a judging section 111 judges the presence or absence of abnormality of the plant according to a predetermined judgment criterion based on an operation of the field device. A storage section 113 stores an operation history of the field device. A display 114 displays the operation history stored in the storage section 113 on a screen. an accepting section 112 accepts an input of the predetermined judgment criterion by a user on a display screen of the display 114.

Next, embodiments of the abnormality monitoring system according to the invention will be described.

### First Embodiment

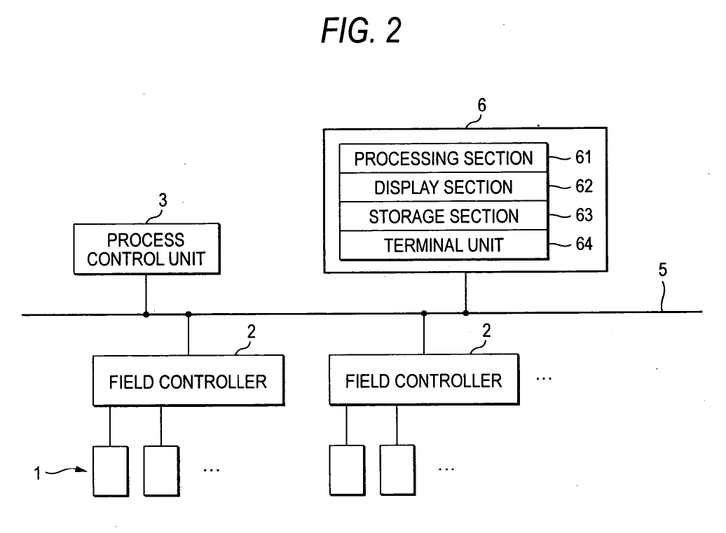

A first embodiment of the abnormality monitoring system according to the invention will be described below with reference to FIGS. 2 to 4.

FIG. 2 is a block diagram showing a configuration of a plant control system to which the abnormality monitoring system of the present embodiment is applied.

As shown in FIG. 2, the plant control system includes field controllers 2 for controlling field devices 1 such as a heat exchanger, a valve, a compressor or a pump, which are installed in a plant, and a process control unit 3 for conducting communication between the field controllers 2 which are distributed and arranged in the plant, controlling each of the field devices 1, and making an automatic running of a process. As shown in FIG. 2, the field controllers 2 and the process control unit 3 are mutually connected through a communication line 5.

Also, a device monitoring unit 6 for monitoring abnormality of the plant through operations of the field devices 1 is connected to the communication line 5.

As shown in FIG. 2, the device monitoring unit 6 includes a processing section 61 for performing control of each section of the device monitoring unit 6 and various information processing, a display section 62 for displaying a processing result, etc., in the processing section 61, a storage section 63 for storing history data, etc., indicating operation histories of the field devices 1, and a terminal unit 64 for accepting an operation by a user.

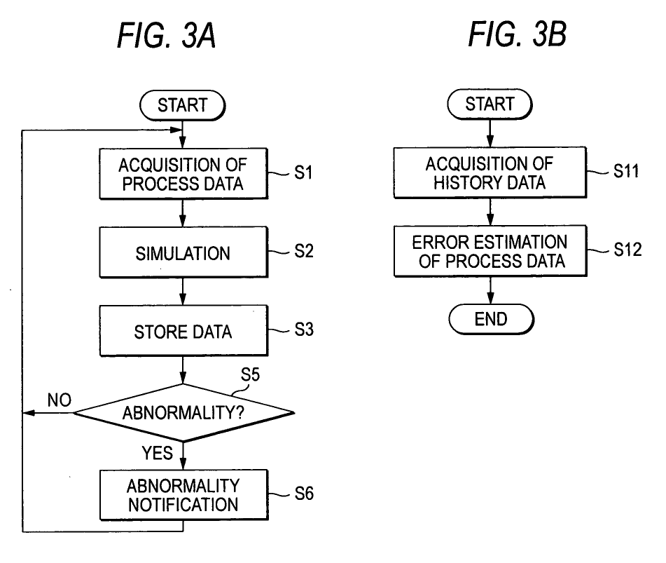

FIGS. 3A and 3B are flowcharts showing a processing procedure of abnormal monitoring in the device monitoring unit 6. This processing procedure is executed based on control of the processing section 61.

In step S1 of FIG. 3A, process data of the field device 1 is acquired through the corresponding field controller 2. The process data is data recognized in the plant control system as input-output data handled by the field device 1. In step S1, the process data is acquired in real time.

Next, in step S2, an operation of this field device 1 is simulated using a device model of the corresponding field device 1. The device model represents characteristics of a device by a material balance expression or a heat balance expression. Here, input data estimated to be equal to the actual field device 1 is given to the corresponding device model and the output data at that time is computed. The input data given to the device model is data in which an error correction is added to process data indicating the input data. The error correction of process data will be described below.

The device model may be configured to be incorporated into a cassette type. As a result of this, the device model can be replaced easily.

Then, in step S3, the process data acquired in step S1 and a simulation result using the device model in step S2 are stored in the storage section 63 as history data.

Then, in step S5, the presence or absence of abnormal occurrence is determined based on output data of the actual field device 1 and output data obtained by simulation. The former is output data indicated by the process data acquired in step S1, and the latter is output data acquired in step S2. In the case of determining that the abnormal occurrence is present in step S5, the flowchart proceeds to step S6 and in the case of determining that it is normal, the flowchart returns to step S1 and the processing described above is repeated.

In step S5, the output data of the actual field device 1 is compared with the output data obtained by simulation.

A method of determination processing in step S5 is not limited and, for example, the presence or absence of abnormal occurrence is determined by the following technique using a threshold value.

(1) The determination is made based on duration time for which a difference between both the output data exceeds a predetermined threshold value. For example, when a difference between the output data continuously (for example, for a predetermined period of time) exceeds a predetermined threshold value in comparison in step S5, it is determined that abnormal occurrence is present.

(2) The determination is made based on the number of times for which a difference between both the output data exceeds a predetermined threshold value within a predetermined time. For example, when a difference between the output data exceeds a predetermined threshold value a predetermined number of times in comparison in step S5 within a predetermined time, it is determined that abnormal occurrence is present.

(3) The determination is made based on accumulation time for which a difference between both the output data exceeds a predetermined threshold value within a predetermined time. For example, the number of times for which a difference between the output data exceeds a predetermined threshold value in comparison in step S5 is counted, and when the number of counts reaches a predetermined number of times, it is determined that abnormal occurrence is present.

In step S6, the corresponding field controller 2 is notified of the abnormal occurrence and the flowchart returns to step S1. In this case, processing according to an abnormal occurrence state is performed in the plant control system.

Next, a procedure of an error correction of process data will be described. In the embodiment, the error correction of process data is previously made by step S11 and step S12 of FIG. 3B. As described above, the process data in which the error correction is made is used as the input data given to the device model.

In step S11 of FIG. 3B, the stored history data for the corresponding field device 1 is acquired from the storage section 63.

Next, in step S12, error estimation (data reconciliation) between input data actually inputted to the field device 1 and process data indicating its input data is executed based on process data indicating input-output data of the field device 1 included in the history data. Thereafter, the processing is ended.

An error generally exists between process data and actual input-output data. However, in the embodiment, an error of process data corresponding to input data is corrected by processing of the data reconciliation, and an operation of the field device 1 is simulated based on the process data after correction (step S2). As a result of this, behavior of the field device can be represented more exactly and accuracy of simulation using a model device can be improved.

Next, a setting procedure of a model parameter will be described. The model parameter is a parameter for defining an operation of simulation (step S2) in a model device. In the embodiment, the model parameter of the model device can be set and changed based on instructions of a user.

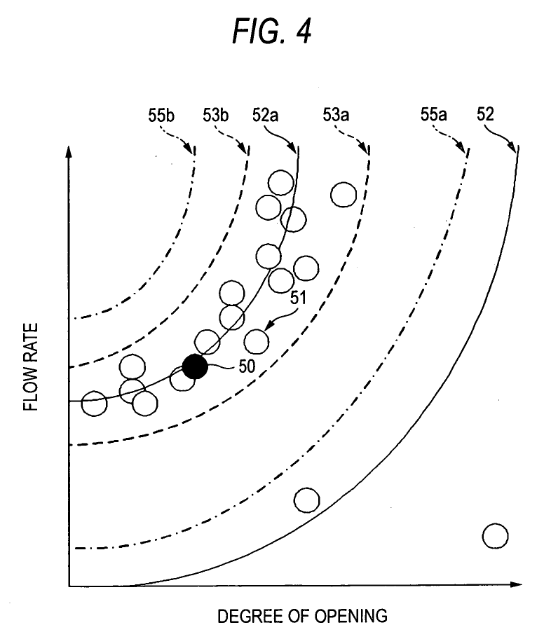

The model parameter can be set and changed on a display screen of the display section 62. FIG. 4 is a diagram illustrating the display screen of the display section 62 at the time of changing the model parameter. This example shows the case of changing a model parameter about a flow rate and an opening of a valve as the field device 1.

As shown in FIG. 4, the present actual measured value 50 in the actual field device 1, the past actual measured values 51 in the field device 1 and a curved line 52 indicating a simulation result by the present model parameter are displayed on the display screen of the display section 62. The actual measured value 50 is the present process data of the field device 1. The actual measured values 51 are process data stored in the storage section 63 as history data, and are data acquired from the storage section 63 by the processing section 61.

In the example shown in FIG. 4, a position of the curved line 52 does not match with distribution of the actual measured values 51, and deviates from the distribution. A user can move the position of the curved line 52 on a display screen using a mouse, etc., included in the terminal unit 64. For example, by moving the curved line 52 to a position of a curved line 52a, the distribution of the actual measured values 51 can be matched with a simulation result. In this case, a model parameter is automatically set at a value corresponding to the curved line 52a. The newly set model parameter is stored in the storage section 63 as a part of the history data.

In the embodiment, thus, rather than inputting the value itself of the model parameter, a model parameter to perform proper simulation is selected by a manipulation on the display screen. As a result of this, a proper model parameter can be selected by a visual and intuitive manipulation while seeing the past actual measured values. Also, a proper model parameter can be selected on the display screen without considering physical property data such as viscosity or specific gravity of a fluid substance.

In addition, it may be constructed so that curved lines indicating simulation results for model parameters of plural values are displayed and a user specifies an arbitrary curve line from among these curved lines and thereby the model parameter can be selected.

Plural model parameters can also be set and changed by one display screen. For example, when the curved line 52 of FIG. 4 is determined by plural model parameters, it may be constructed so as to automatically set values of the plural model parameters according to the curved line 52 created by a manipulation of a user.

Also, in the embodiment, a threshold value for abnormal diagnosis can be set and changed on the display screen of FIG. 4. In FIG. 4, a boundary line 53a and a boundary line 53b indicate threshold values. An area surrounded by the boundary line 53a and the boundary line 53b indicates normality, and its outside area indicates abnormality.

A user specifies positions of the boundary line 53a and the boundary line 53b on the display screen and thereby, a proper threshold value can be determined by a visual and intuitive manipulation while seeing the past actual measured values and a simulation result by the present model parameter. In addition, the positions of the boundary line 53a and the boundary line 53b can be set by a manipulation similar to setting and change of the model parameter. The newly set threshold value is stored in the storage section 63 as a part of the history data.

Also, it may be constructed so as to indicate a threshold reference value on a display screen. In the example of FIG. 4, a curved line 55a and a curved line 55b indicating values of 3σ of the past actual measured values are displayed as a value deviating from an average of the past actual measured values by a predetermined amount. In this case, a user can set a threshold value while seeing a threshold reference value.

As described above, in the embodiment, a result of simulating behavior of the field device is compared with an operation of the actual field device, so that the operation of the field device can be monitored with high accuracy. Therefore, a state of a process can be monitored exactly in online real time.

Also, with respect to process data indicating input data of the field device 1, the error estimation and correction are performed as preprocessing and the process data after correction is used as input data of simulation. Thus, behavior of the field device 1 can be represented more exactly by the error correction of the process data inputted to a model device.

In the embodiment, simulation of the field device 1 can be executed using software. As a result of this, each of the field devices can be simulated by preparing modules every device model such as a heat exchanger, a valve, a compressor or a pump and selecting the module. It can cope flexibly with an increase in kinds or the number of field devices by adding such modules in a cassette form.

Further, in the embodiment, the model parameter and the threshold value are set and changed by a manipulation on the display screen on which the past actual measured values are displayed. As a result of this, these values can easily be set and changed visually and intuitively, and time or labor necessary for the setting and change can be saved.

### Second Embodiment

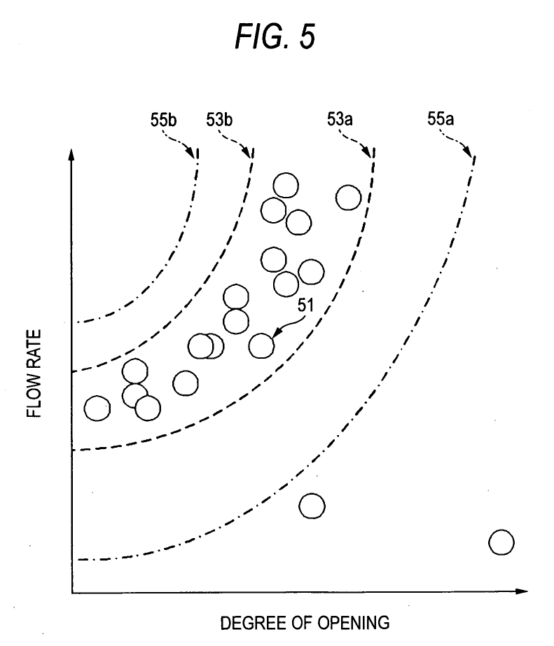

A second embodiment of the abnormality monitoring system according to the invention will be described below with reference to FIG. 5.

In the abnormality monitoring system of the present embodiment, the case of monitoring abnormality of a plant based on input-output data of a field device without simulating the field device is shown.

FIG. 5 is a diagram illustrating a display image for setting a threshold value used in abnormal diagnosis. This example shows the case of setting a threshold value about a flow rate and an opening of a valve as a field device 1.

As shown in FIG. 5, the past actual measured values 51 in the field device 1, and a boundary line 53a and a boundary line 53b indicating the present threshold values are displayed on a display screen. The actual measured value 51 are process data stored as history data. Also, an area surrounded by the boundary line 53a and the boundary line 53b indicates normality, and its outside area indicates abnormality.

A user sets a threshold value by specifying positions of the boundary line 53a and the boundary line 53b on the display screen shown in FIG. 5 using a mouse, etc. Therefore, the user can determine a proper threshold value by a visual and intuitive manipulation while seeing the past actual measured values. As a result of this, the threshold value can easily be set at a proper value and accuracy of abnormal monitoring can be improved.

Also, it may be constructed so as to indicate a threshold reference value on a display screen in a manner similar to the first embodiment (FIG. 4). In the example of FIG. 5, a curved line 55a and a curved line 55b, etc., indicating values of 3σ are displayed as a value deviating from an average of the past actual measured values by a predetermined amount in a manner similar to the example of FIG. 4. In this case, a user can set a threshold value while seeing a threshold reference value.

In the embodiment, the threshold value is set and changed by a manipulation on the display screen on which the past actual measured values are displayed, so that the threshold value can easily be set and changed visually and intuitively.

The scope of application of the invention is not limited to the embodiments described above. The invention can be widely applied to systems for monitoring abnormality of a plant.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. An abnormality monitoring system for monitoring abnormality of a plant, the abnormality monitoring system comprising:
a simulation section which simulates an operation of a field device in the plant by using a device model;
a comparing section which compares actual output data of the field device with simulation output data that is obtained by simulation by the simulation section; and
a judging section which judges occurrence of abnormality of the plant based on a comparison result by the comparing section.

2. The abnormality monitoring system as claimed in claim 1, further comprising:
an error estimating section which estimates an error between process data and input data, the process data being indicated as the input data to the field device, and the input data being actually inputted to the field device,
wherein the process data is corrected based on an estimation result by the error estimating section, and
the corrected process data is inputted to the device model.

3. The abnormality monitoring system as claimed in claim 1, wherein the judging section judges the occurrence of the abnormality based on duration time for which a difference between the simulation output data and the actual output data compared by the comparing section exceeds a threshold value.

4. The abnormality monitoring system as claimed in claim 1, wherein the judging section judges the occurrence of the abnormality based on a number of times for which a difference between the simulation output data and the actual output data compared by the comparing section exceeds a threshold value within a predetermined time.

5. The abnormality monitoring system as claimed in claim 1, wherein the judging section judges the occurrence of the abnormality based on accumulation time for which a difference between the simulation output data and the actual output data compared by the comparing section exceeds a threshold value within a predetermined time.

6. The abnormality monitoring system as claimed in claim 3, further comprising:
a threshold value defining section which defines the threshold value based on an instruction of a user.

7. The abnormality monitoring system as claimed in claim 6, further comprising:
a storage section which stores an operation history of the field device; and
a display which displays the operation history stored in the storage section on a screen,
wherein the threshold value defining section accepts the instruction of the user on the screen of the display.

8. The abnormality monitoring system as claimed in claim 1, further comprising:
a device model parameter defining section which defines the device model based on an instruction of a user.

9. The abnormality monitoring system as claimed in claim 8, further comprising:
a storage section which stores an operation history of the field device; and
a display which displays the operation history stored in the storage section on a screen,
wherein the device model parameter defining section accepts the instruction of the user on the screen of the display.

10. An abnormality monitoring system for monitoring abnormality of a plant, the abnormality monitoring system comprising:
a judging section which judges occurrence of abnormality of the plant based on a judgment criterion and an operation of a field device in the plant;
a storage section which stores an operation history of the field device;
a display which displays the operation history stored in the storage section on a screen; and
an accepting section which accepts an input of the judgment criterion by a user on the screen of the display.

11. The abnormality monitoring system as claimed in claim 10, wherein the judging section judges the occurrence of the abnormality by using a threshold value corresponding to the judgment criterion.

12. The abnormality monitoring system as claimed in claim 11, wherein the accepting section accepts the input of the threshold value by designation of a region by the user on the screen.

13. An abnormality monitoring method for monitoring abnormality of a plant, the abnormality monitoring method comprising:
simulating an operation of a field device in the plant by using a device model;
comparing actual output data of the field device with simulation output data that is obtained by the simulation; and
judging occurrence of abnormality of the plant based on a result of the comparison.

14. The abnormality monitoring method as claimed in claim 13, further comprising:
estimating an error between process data and input data, the process data being indicated as the input data to the field device, and the input data being actually inputted to the field device,
wherein the process data is corrected based on a result of the estimation, and
the corrected process data is inputted to the device model.

15. The abnormality monitoring method as claimed in claim 13, wherein the occurrence of the abnormality is judged based on duration time for which a difference being compared between the simulation output data and the actual output data exceeds a threshold value.

16. The abnormality monitoring method as claimed in claim 13, wherein the occurrence of the abnormality is judged based on a number of times for which a difference being compared between the simulation output data and the actual output data exceeds a threshold value within a predetermined time.

17. The abnormality monitoring method as claimed in claim 13, wherein the occurrence of the abnormality is judged based on accumulation time for which a difference being compared between the simulation output data and the actual output data exceeds a threshold value within a predetermined time.

18. The abnormality monitoring method as claimed in claim 15, further comprising:
defining the threshold value based on an instruction of a user.

19. The abnormality monitoring method as claimed in claim 18, further comprising:
storing an operation history of the field device; and
displaying the stored operation history on a screen,
wherein the threshold value is defined by accepting the instruction of the user on the screen.

20. The abnormality monitoring method as claimed in claim 13, further comprising:
defining the device model based on an instruction of a user.

21. The abnormality monitoring method as claimed in claim 20, further comprising:
storing an operation history of the field device; and
displaying the stored operation history on a screen,
wherein the device model is defined by accepting the instruction of the user on the screen.

22. An abnormality monitoring method for monitoring abnormality of a plant, the abnormality monitoring method comprising:
judging occurrence of abnormality of the plant based on a judgment criterion and an operation of a field device in the plant;
storing an operation history of the field device;
displaying the stored operation history on a screen; and
accepting an input of the judgment criterion by a user on the screen.

23. The abnormality monitoring method as claimed in claim 22, wherein the occurrence of the abnormality is judged by using a threshold value corresponding to the judgment criterion.

24. The abnormality monitoring method as claimed in claim 23, wherein the input of the threshold value is accepted by designation of a region by the user on the screen.
